(19) United States
(12) Patent Application Publication
(10) Pub. No.: US 2020/0378409 A1
(43) Pub. Date: Dec. 3, 2020

(54) VALVE DEVICE

(71) Applicant: HYDAC FLUIDTECHNIK GMBH, Sulzbach/Saar (DE)

(72) Inventors: Peter BRUCK, Althornbach (DE); Frank SCHULZ, Blieskastel-Bierbach (DE); Christian STAUCH, Schwalbach (DE); Jan LÜBBERT, Dresden (DE)

(21) Appl. No.: 16/970,715

(22) PCT Filed: Feb. 7, 2019
(86) PCT No.: PCT/EP2019/052965

§ 371 Date: Aug. 18, 2020

(30) Foreign Application Priority Data
Feb. 20, 2018 (DE) 10 2018 001 303.1

(51) Int. Cl. F15B 13/04; F15B 11/044

(52) U.S. Cl. CPC F15B 13/0417; F15B 11/044; F15B 2211/30515; F15B 2211/3055; F15B 2211/3057; F15B 2211/3058; F15B 2211/6313; F15B 2211/365; F15B 2211/46; F15B 2211/50554; F15B 2211/5151; F15B 2211/526; F15B 2211/353

(57) ABSTRACT

A valve device having an inlet port (ZA) of an inlet side for supplying a hydraulic consumer with hydraulic fluid, wherein said hydraulic consumer can be connected to the inlet port (ZA), having an outlet port (AA) of an outlet side for discharging pressurized fluid from the connectable consumer, wherein, depending on the direction of actuation of this consumer, the inlet side becomes the outlet side and the outlet side becomes the inlet side, having a pressure supply port (P), and having a return port (T), is characterized in that a pressure regulating device is acting on the respective inlet side and a volume flow regulating device is acting on the respective outlet side.

The invention relates to a valve device having an inlet port of an inlet side for supplying a hydraulic consumer with hydraulic fluid wherein said hydraulic consumer can be connected to the inlet port, having an outlet port of an outlet side for discharging pressurized fluid from the connectable consumer, wherein, depending on the direction of actuation of this consumer, the inlet side becomes the outlet side and the outlet side becomes the inlet side, having a pressure supply port and having a return port.

From EP1 642 035 B1 a hydraulic system is known having a hydraulically controllable drive part as a hydraulic consumer having two opposite drive directions, wherein at least one pressure regulator, in particular having the form of a valve, is provided for at least one drive direction, and a throttle is provided between the pressure regulating valve and the drive part, wherein for detecting the load state of the drive part a sensor system is provided in the form of a pressure value sensor, which is installed in the assigned fluid-conveying line between the throttle and the drive part for each drive direction of the drive part. Because in the known solution the pressure value sensor detects the current load situation at the drive part, the pressure regulator in its basic position connects the secondary side of the system to a tank port or return port, and, when the pressure regulator is activated, the secondary pressure is regulated to the pressure of the proportional pilot control minus the spring force acting on the valve piston of the pressure regulator, a control and regulation concept is implemented in an advantageous way, which, based on a basic system, can be used to measure pressure, distance, speed and position of the movable components of the respective selected drive part for hydraulically controllable drive parts or consumer, such as hydraulic working cylinders or hydraulic drive motors. The respective pressure regulator, in particular having the form of a valve, can be used to implement dynamic and precise control processes by means of the known system solution depending on the hydraulic application. By means of the known hydraulic system using pressure regulators and corresponding throttles, the previously known conventional directional valve technology for controlling the motion of a hydraulic consumer can be dispensed, such that power loss and susceptibility to faults are reduced, while simultaneously the response time for the hydraulic system is shortened.

Such hydraulic systems, whether in the form of stationary systems or mobile working machines, are subject to ever increasing demands in terms of productivity, flexibility and energy efficiency. For large machines, such as those used in the mining industry for instance, multi-circuit systems, i.e. hydraulic structures having assigned pumps for the various consumers, are becoming increasingly common. The allocation of the performance requirements has an enormous energetic potential. However, in cost- and installation space-sensitive applications such multi-circuit systems are difficult to use from an economic and structure point of view.

Based on this state of the art, the invention addresses the task of simplifying such known hydraulic structures and replacing them with a more efficient control or valve concept to reduce their respective energy consumption, thus not only reducing operating costs but also making a contribution to the increasingly stringent statutory exhaust gas regulations.

A valve device having the features of patent claim 1 in its entirety solves this task. Because, according to the characterizing part of patent claim 1, a pressure regulating device acts on the respective inlet side and a volume flow regulating device acts on the respective outlet side, a kind of decentralized valve control is created having so-called separate control edges, permitting the separate control of valve elements on the inlet end and outlet side of a hydraulic consumer, such as a hydraulic working cylinder, which can be connected to the valve device. In addition to the individual actuation of the inlet and outlet, switching topologies can be implemented, including, for instance, float or rapid-traverse positions.

The valve device according to the invention fulfills the requirements in the context of the motion tasks for the hydraulic consumer, i.e. it can set a certain speed on the one hand and on the other hand it can ensure that the inlet side of the consumer is sufficiently filled in case of supporting, so-called regenerative loads. To this end, the valve device according to the invention uses a hydraulic-mechanical regulation for the variables volume flow and pressure.

It is advantageous to place the volume flow regulation on the outlet side of the loads each, because in this way the same flow regulator can be used to set the motor loads and regenerative loads to a defined speed. Accordingly, the pressure regulation is then located on the inlet side, preventing filling shortages in case of lowering motions (regenerative load) assuming a sufficient supply based on the hydraulic-mechanical adjustment of a sufficiently high filling pressure.

If the valve device according to the invention is used for a hydraulic consumer, such as a hydraulic working cylinder or a hydraulic motor that can travel in opposing directions, the addressed inlet side then becomes the outlet side and the outlet side becomes the inlet side for the consumer when the direction of motion or actuation is changed. In this respect, the valve device according to the invention ensures that using only one device, even for changing actuation directions, always the pressure regulation device has a controlling effect on the inlet side having the pressure supply and a volume flow regulation device has a controlling effect on the fluid flow on the respective outlet side.

The valve device according to the invention is capable of utilizing the energetic, functional and structural potentials of separate control edges in valves and simultaneously of mastering the resulting complexity on the component and control levels. The valve device according to the invention can be operated in an energetically favorable way, which contributes to the reduction of operating costs and, due to the improved control concept having separate control edges, in the context of the pressure supply, regularly provided by motor-driven hydraulic pumps, drive energies can be reduced, which improves exhaust gas values.

In a preferred embodiment of the valve device according to the invention, provision is made for the pressure regulating device and the volume flow regulating device each have a proportional valve in addition to a pressure compensator and a pressure regulation valve regarding their functionality, which are interconnected and controlled such that, when the inlet port is supplied from the side of the pressure supply port in one direction of flow, the pressure regulation valve operates, and when a predeterminable set pressure is exceeded at the other pressure regulation valve on the side of the outlet port, this direction of flow reverses. The pressurized fluid flows in the direction of the return port via the other proportional valve and the assigned pressure compensator, both of which work as flow regulating valves regarding their functionality. In this way, the valve device according to the invention can be implemented in a “dissolved structure” having individual, structurally separate valve components.

However, it is particularly advantageous to combine the above-mentioned valve components, in particular the respective pressure regulating valve and the respective assigned pressure compensator, to a single combination valve in terms of their functions.

It is preferably provided that the combination valve has two spools, which can be moved independently in a valve housing, in the form of a pressure regulating spool and in the form of a pressure compensator spool, which control the possible fluid-conveying connections between the pressure supply port, the return port and a working port, which forms the inlet port and the outlet port, respectively, for the hydraulic consumer in the one and in the other opposite direction of flow. In this way, a decentralized valve control having separate control edges can be implemented using only one combination valve having two independently movable spools in the valve housing, providing not only an improved control geometry but also structural advantages, in particular with regard to the reduction of the complexity of the hose and pipe system compared to known solutions having individual, spatially separated single valves.

Further advantageous embodiments of the valve device according to the invention are the subject matter of the further dependent claims.

The valve device according to the invention is described below in greater detail on the basis of embodiments shown in the drawing. In the figures, in principle and not to scale,

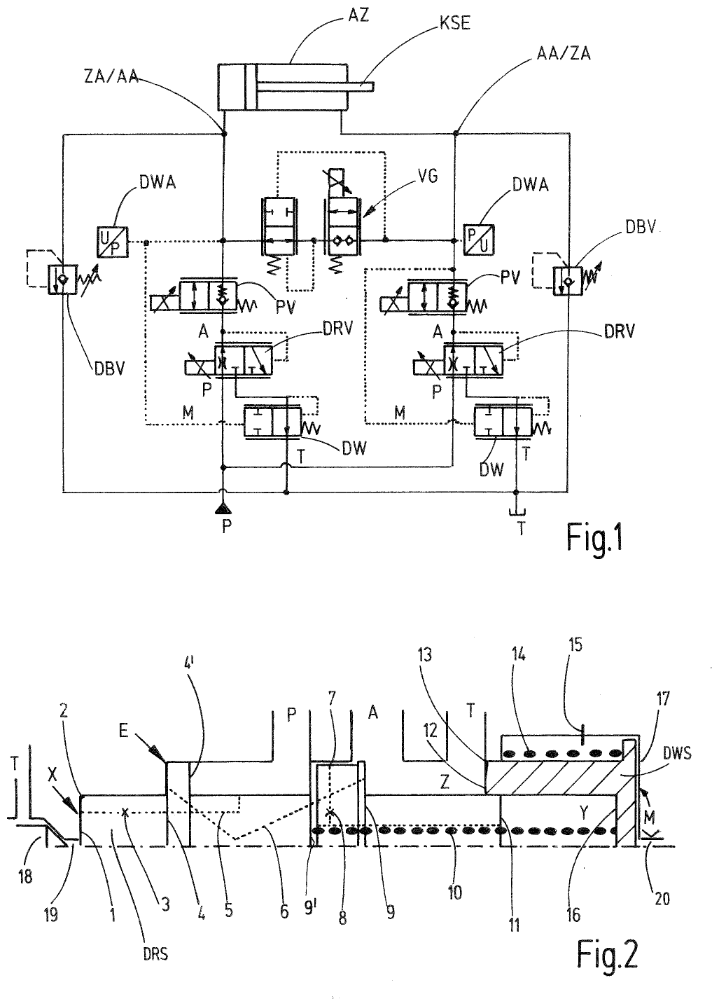

FIG. 1 shows, in the manner of a hydraulic diagram, a first embodiment of the valve device according to the invention in a “dissolved” structure having a large number of individual valve components;

FIGS. 2 to 6 show a second embodiment of the valve device according to the invention, wherein in said second embodiment the functions of the individual valve components according to FIG. 1 are combined in a combination valve.

The valve device shown in FIG. 1 has an inlet port ZA of an inlet side for supplying a hydraulic consumer with hydraulic fluid, wherein said hydraulic consumer is connectable to the inlet port ZA. In addition, an outlet port AA of an outlet side is provided for discharging hydraulic fluid from the connectable consumer. Furthermore, the valve device has a pressure supply port P for supplying the valve device and the hydraulic consumer with hydraulic fluid of a pre-determinable pressure and, further, a return port T or a tank port is provided for discharging displaced fluid from the hydraulic consumer and the valve device. The hydraulic consumer is formed by a hydraulic working cylinder AZ having a piston rod unit KSE, wherein the piston side of the working cylinder AZ is permanently connected to the inlet port ZA in a fluid-conveying manner and the rod side is connected to the outlet port AA in accordance with the illustration in FIG. 1. If the piston side of the piston rod unit KSE is supplied with pressurized fluid at a predeterminable pressure via the supply port ZA, the piston rod unit KSE, viewed in the direction of FIG. 1, extends to the right and the fluid in the rod chamber is discharged from the working cylinder AZ via the outlet port AA. In the reverse case, i.e. when the piston rod unit KSE retracts, viewed in the direction of FIG. 1, to the left, the outlet port AA then becomes the inlet port ZA and the fluid displaced on the piston side during the retraction motion of the piston rod unit KSE exits the working cylinder AZ via an outlet port AA, which originally formed the inlet port ZA during the extension motion. So the piston rod unit KSE of the working cylinder AZ performs a reciprocating motion depending on the supply state of the pressurized fluid, and to this extent a motion in opposing axial directions. Instead of the working cylinder AZ, a hydraulic motor unit (not shown) could also take the place of the hydraulic consumer, wherein said hydraulic motor unit can also rotate in opposing directions, depending on the filling status of its chambers.

As FIG. 1 shows, there is a 3/2 proportional spool valve PV with a pressure compensator DW on both the inlet side and the outlet side of the valve device. As shown in FIG. 1, the input of the 3/2 proportional spool valve PV is connected to a conventional pressure supply source, such as a hydraulic pump, via the pressure supply port P. The output of the proportional valve PV is formed in the manner of a utility port and is designated by A. The proportional valve PV can be electromagnetically controlled, as shown, and the opposite control side of the valve spool is controllable by the control pressure from the utility port A. The volume flow, coming from the utility port A, is routed to an input of the pressure compensator DW, which, in the position of the pressure compensator shown, routes the pressure at the utility port A to the tank or return port T. In another regulating position of the respective pressure compensator DW, the latter takes up a position blocking the fluid path thereto. Furthermore, one control side of the respective pressure compensator DW is acted upon by an energy accumulator, in particular in the form of a compression spring, and further the return pressure from the utility port A is also present as the control pressure, provided that the respective proportional valve PV takes up its further spool position, as shown in FIG. 1, in which the fluid-conveying connection from the pressure supply port P to the utility port A is blocked and apart from that there is a fluid connection backflowing from utility port A in the direction of one control side of the pressure compensator DW. On the opposite control side of the respective pressure compensator DW, the pressure PM is present at a measurement port M, which is tapped at the inlet port ZA or the outlet port AA of the working cylinder AZ, respectively.

Furthermore, according to the hydraulic diagram of FIG. 1, both the respective inlet port ZA and the respective outlet port AA are protected in the usual way against excessive operating pressure in the direction of the return port T using an adjustable pressure limitation valve DBV. A control device, not further specified and shown, is used for the electromagnetic control of the respective pressure regulating valve DRV, which evidently processes the measuring pressure determined by pressure value sensors DWA at the inlet port ZA or at the outlet port AA, respectively, and transmits control signals to the pressure regulating valves DRV and to the electromagnetically actuated proportional valves PV for controlling the latter.

If, according to the illustration of FIG. 1, fluid now flows from bottom to top, i.e. from the pressure supply port P to the consumer A, the 3/2 proportional spool valve arranged on the supply side acts as a pressure regulator. If the pressure at the utility port A of the pressure regulator on the outlet side now exceeds the set pressure preset by means of its proportional solenoid DRV, the direction of flow reverses and the hydraulic fluid (oil) flows into the utility port A and from there through the pressure compensator DW, shown on the right in FIG. 1, into the return port T. The right pressure compensator DW compares the pressure at the utility port A with the pressure PM at the measurement port M. In this return flow condition, the right 3/2-proportional spool valve DRV then acts as a directional valve, wherein the control edge of the utility port A towards the pressure compensator DW on the right is fully open. In combination with the shown right proportional valve PV between the ports A and M, the arrangement shown then acts as a flow regulating valve.

The valve device shown in FIG. 1 in a so-called dissolved structure thus offers a hydraulic-mechanical regulation of the variables volume flow rate and pressure. In doing so, as stated, the volume flow regulation was applied to the outlet side of the hydraulic consumer, because in this way the same flow regulator can be used to set the motor loads and regenerative loads to a defined speed. Consequently, the pressure regulation is then located on the supply side, preventing filling shortages in case of lowering motions (regenerative load) assuming a sufficient supply based on the hydraulic-mechanical regulation of a sufficiently high filling pressure. If the conditions now reverse, i.e. the piston rod unit KSE of the working cylinder AZ retracts to the left as shown in FIG. 1, the previous inlet port ZA becomes the outlet port AA and the previous outlet port AA becomes the inlet port ZA. The pressure regulating valve DRV, shown on the right in FIG. 1, then forms the pressure regulator and the combination, shown on the left, of proportional valve PV with the pressure compensator DW forms the flow regulator.

A principle arrangement according to FIG. 2 shows a possible structure of a so-called combination valve, which combines the function of one pressure regulating valve DRV each together with the assigned pressure compensator DW in one valve construction. For an improved and simplified illustration, the essential components of the combination valve are shown only in principle and simplified; and in addition, only the upper half, above its axis of actuation, of the combination valve is shown, wherein the rotationally symmetrical overall valve housing of the combination valve is not shown for the sake of simplicity, but of course comprises the valve mechanism explained in more detail below and keeps passages forming the individual ports P, A, T, M open.

The valve shown in FIG. 2 has two spools in the form of a pressure regulating spool DRS shown on the left, the other being a pressure compensator spool DWS shown on the right. The corresponding two spools DRS and DWS control the fluid-conveying connections between the pressure supply port P, the utility port A and the return port T, which forms the tank port in this respect. The return port Tor the tank port, further shown on the left in FIG. 2, of a pilot control stage formed by a pilot cone 18, which can be controlled by an actuation solenoid of the usual type for the combination valve shown, is combined with the main tank port (return port T) shown on the right, but this is not mandatory.

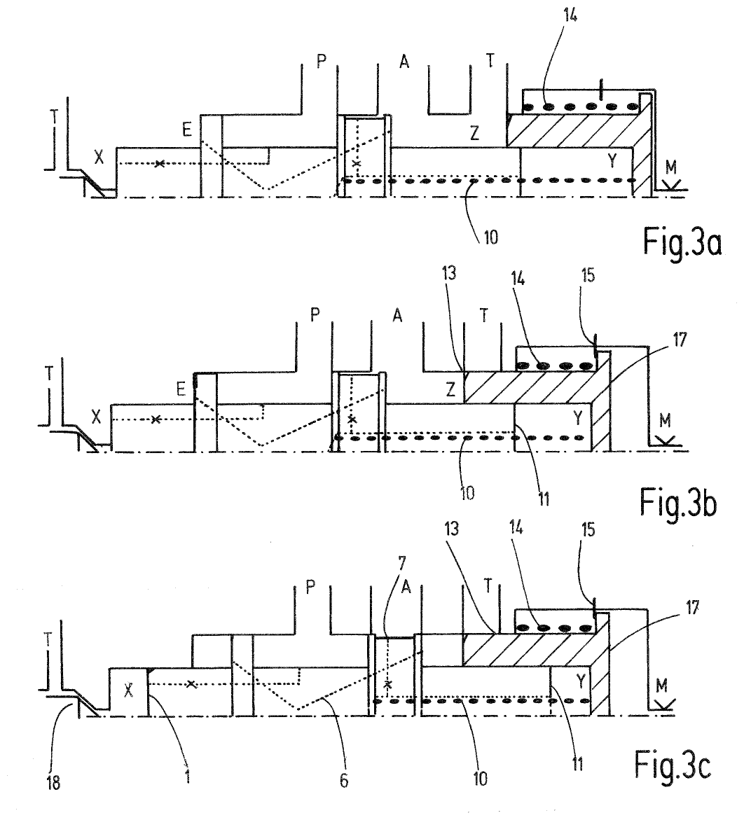

Furthermore, there are various chambers in the form of a pilot control chamber X, in which a control pressure p_{X} originating from the pressure supply port P is present, wherein said control pressure p_{X} acts from the left to the right on the pressure regulating spool DRS in proportion to the force of the energized actuating solenoid or proportional solenoid, respectively. A pilot channel 5 is provided for connecting the pressure supply port P and the pilot control chamber X, wherein said pilot channel 5 has an orifice 3 or an flow regulating valve, not shown in detail, as pressure distributor of the pilot control. In this respect, the pilot pressure p_{X} is present at a signaling surface 1, which, viewed in the direction of FIG. 2, forms the left end face of the pressure regulating spool DRS and, in the displacement position of the pressure regulating spool DRS shown in FIG. 2, the pilot control chamber X, which is otherwise limited by the valve housing, is essentially reduced to zero except for a notch, designated by 2, for the hydraulic end position of the pressure regulating spool DRS in its right end or stop position shown in FIGS. 3a, 3b.

Furthermore, FIG. 2 shows a compensation chamber E, which, according to the illustration in FIG. 2, is also essentially reduced to volume zero. The compensation chamber E is limited by the valve housing and by a compensation surface 4 as part of a ring collar, which is radially widened compared to the other diameter of the pressure regulating spool DRS. The annular surface 4′, opposite the compensation surface 4, of the annular collar, which in this case has the same diameter as the compensation surface 4, is directly exposed to the supply pressure p_{X} at the pressure supply port P. Furthermore, the compensation chamber E is permanently connected to the utility port A in a fluid-conveying manner via the compensation channel 6, shown in a dashed line, in the pressure regulating spool DRS. Accordingly, the compensation channel 6 opens out at a further or right annular surface 9 of the pressure regulating spool DRS, wherein the annular surface 9 has the same diameter as the annular surface 4, which in this respect is a compensation surface for the surface 9, which is of particular importance for the function. The right annular surface 9 is also part of an annular collar having a further stop face 9′ of the same diameter, which in the position shown co-limits the pressure supply port P. The diameters of the surfaces 4′ and 9′ can be different from each other, only the diameters of the surfaces 4 and 9 have to be identical.

Furthermore, there is an interstice Z in the connection between the utility port A and the return port T, wherein in said interstice there is a pilot pressure p_{Z} resulting from this connection. The utility port A and the main return port T open radially into the interstice Z, which extends in parallel to the pressure regulating spool DRS.

In addition, there is an actual-pressure signal chamber Y, which, viewed in the direction of FIG. 2, is delimited on the left side by a signaling surface 11 for the actual pressure p_{A} during the pressure regulating operation and otherwise by a cylindrical recess in the pressure compensator spool DWS, the left annular surface 12 of which encroaches on or encompasses a right free end area of the cylindrical pressure regulating spool DRS. While the signaling surface 11 forms the right free front end of the pressure regulating spool DRS, on the opposite side there is an circular surface 16 having the same diameter on the inside of the pressure compensator spool DWS. Any control pressure p_{A} that originates from the utility port A is thus pressure-effectively present at the signal surface 11 and the circular surface 16 of the pressure compensator spool DWS. In this respect, the signal or control pressure p_{A} is transmitted to the surfaces 11 and 16 during the operation of the pressure compensator. The free volume of the actual-pressure signal chamber Y changes because of the possible travel motion of the two spools DRS and DWS. To be able to transmit the control pressure p_{A} from the utility port into the actual-pressure signal chamber Y, a signaling channel 7 (shown by a dashed line) is used, which opens into a center collar or ring collar having a reduced diameter compared to the ring surfaces 9, 9′, wherein said center or ring collar is connected permanently in a fluid-conveying manner to the utility port A. At its other end, the corresponding signaling channel 7 for the actual or control pressure p_{A} at the utility port A opens into the actual-pressure signal chamber Y. In addition, a dampening orifice 8 can be optionally provided in the signal channel 7, if required.

The pressure compensator spool DWS uses a widened flange surface at the end to rest against an energy accumulator in the form of a compression spring 14 for the pressure compensator, wherein the corresponding compression spring 14 is relatively hard. Furthermore, there is a stop 15 for the free motion of the pressure compensator spool DWS to the left in the valve housing, which is not specified in detail. In this respect, the end, opposite from the flange surface of the pressure compensator spool DWS, of the spring 14 also rests against wall parts of a corresponding valve housing. In addition, according to the illustration in FIG. 2, a further energy accumulator is guided inside the pressure compensator spool DRS in the form of a compression spring 10, which relatively soft co-determines the response behavior of the pressure regulator. One free end of this pressure spring 10 rests against the circular surface 16 of the pressure compensator spool DWS and its other free end rests against the end face of a drilled hole in the pressure regulating spool DRS.

Furthermore, there is a signal chamber M in the valve housing which, viewed in the direction of FIG. 2, at the left side is delimited by a signaling surface 17, which forms the right free front end of the pressure compensator spool DWS in the area of its flange widening. A measurement port 20 opens into this signal chamber M, wherein said measurement port 20 is pressurized with the measuring pressure p_{M} during the operation of the pressure compensator. In addition, it should be noted that, besides the notch 2 for the hydraulic end position of the pressure regulating spool DRS, a relief notch 13 for the pressure compensator spool DWS is made in the area of the main return port T at the left free front end of the pressure compensator spool DWS, wherein otherwise the corresponding free front end is limited by the annular surface 12, which during the operation of the pressure compensator transfers the pressure p_{A} at the utility port A to the pressure compensator spool DWS. Furthermore, a cone seat 19 for the corresponding pilot cone 18, which can be controlled by the actuating solenoid, is provided in the area of the pilot cone 18 in the valve housing, which is not specified in more detail. The core idea of this valve concept according to the invention is the separation of the tasks of pressure regulation and pressure compensator function, which are distributed to the two spools DRS and DWS, which are provided with independent energy accumulators in the form of the compression springs 10 and 14, wherein the compression spring 10 acts not only on the circular surface 16 of the pressure compensator spool DWS, but also on the pressure regulating spool DRS via a point of contact in the area of the further annular surface 9′.

The left spool or pressure regulating spool DRS implements the pressure regulating function, starting at the pressure supply port P to the pressure port A. The soft spring 10 holds it in the rest position at the left stop. As explained above, the pressure regulating spool DRS has three channels, wherein the pilot channel 5 supplies the pilot stage with fluid (oil) from the pressure supply port P. For the pressure distributor function of the pilot stage, in the channel 5 is used either an orifice 3 or a miniature flow regulating valve (not shown) integrated into the pressure regulating spool DRS. An advantage of the latter solution is the lower and constant pilot flow. Thus, the regulating pressure in the pilot control chamber X is independent of the supply pressure at the port P. However, this is countered by higher production costs. The signal channel 7, on the other hand, reports the actual pressure p_{A} at the utility port A to the interstice Y between the two spools DRS and DWS. A dampening orifice 8 can be optionally used here. The further present channel 6 as a compensation channel effects a pressure compensation between the interstice Z, which is located between the ports A and T, and the compensation chamber E. The notch 2 is used to implement a hydraulic end position for the pressure regulating spool DRS. In this respect, the right spool or pressure compensator spool DWS operates as a pressure compensator, which compares the pressure at the utility port A to the pressure at the measurement port 20 or to the pressure in the signal chamber M, respectively. The structure of the hard spring 14 as the further energy storage defines the resulting difference in regulating pressure.

The mode of operation of the combination valve according to the invention and FIG. 2 is explained in more detail below, wherein in the subsequent figures reference signs are only given in relation to FIG. 2 to the extent that they are essentially required to explain the solution according to the invention.

FIGS. 3a, 3b and 3c represent different rest states of the combination valve, wherein the unloaded rest state as shown in FIG. 3a shows the same valve state as that shown in FIG. 2, and FIG. 3b shows a loaded rest state for the valve, whereas FIG. 3c shows the valve in the loaded rest state and pre-energized.

In this respect, FIGS. 3a, 3b and 3c refer to the possible rest states of the combination valve according to the invention, i.e. the states in which no fluid (oil) flows along the flow paths P-A or A-T. In the unloaded rest state (FIGS. 2 and 3a), all the ports shown are depressurized. The two spools DRS and DWS are arranged in the end positions defined by the springs 10 and 14 and the housing stops. The fluid-conveying connection between the pressure supply port P and the utility port A is closed, the connection from the utility port A to the return port T is fully open.

The loaded rest state according to the illustration in FIG. 3b is indicated by a load pressure at the measurement port 20 or in the signal chamber, respectively, wherein said load pressure acts on the signaling surface 17 on the right side of the pressure compensator spool DWS. The pressure applied to the signaling surface 17 shifts the pressure compensator spool DWS according to the illustration in FIG. 3b into the left end position, which is defined, for instance, by means of the annular stop 15. The tightly sealed holding of the load requires a tightly sealed construction of a sealing point between the signal chamber M and the return port T (not shown). The fluid-conveying connection between the utility port A and the return port T is closed except for the geometrically small relief notch 13.

To bridge the long dead stroke of the pressure regulating spool DRS from the left end position to the opening between the pressure supply port P and the utility port A, it is advisable to pre-energize the actuating solenoid (not shown in detail), which controls the pilot cone 18. This results in a pilot pressure p_{X} in the pilot control chamber X, wherein said pilot pressure p_{X} acts on the signaling surface 1 and shifts the pressure regulating spool DRS so far to the right until it closes the fluid-conveying connection from the utility port A to the interstice Z. It is assumed that no fluid (oil) can flow out of the utility port A because the proportional valve or check valve PV (FIG. 1) connected to the utility port A is closed. During the mentioned motion, viewed in the direction of FIG. 3c, to the right, the front face 11 of the pressure regulating spool DRS displaces a fluid volume or oil volume from the actual-pressure signal chamber Y, wherein this fluid volume can be discharged into the utility port A via the signal channel 7 but from there cannot escape any further from the system due to the closed port valve PV. Therefore, the fluid (oil) is forced to flow into the interstice Z and into the tank or the return port T via the relief notch 13 of the pressure compensator in the form of the pressure compensator spool DWS, until the pressure regulating spool DRS closes the fluid-conveying connection between the utility port A and the interstice Z. This results in a pressure equilibrium between the two circular end faces 1 and 11, which are of equal size in terms of their free diameter, and the rest position shown in FIG. 3c is reached, wherein the compensation chamber E and the interstice Z are always pressure-balanced via the compensation channel 6 in the pressure-regulating spool DRS.

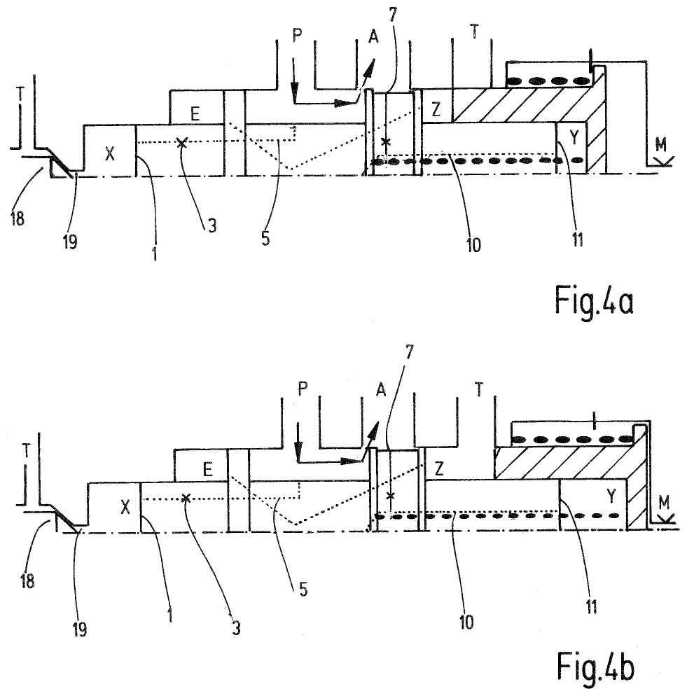

FIGS. 4a and 4b now show the actual pressure regulation operation. Here Fluid (oil) flows from the pressure supply port P to the utility port A. The pressure at the utility port A corresponds to the set pressure, preset in the pilot chamber X using the pilot stage, minus the pressure difference corresponding to the spring force exerted by the preloaded pressure regulating spring 10 on the pressure regulating piston or pressure regulating spool DRS. The pilot stage mentioned above is realized by components denoted by 3, 5, 18 and 19. The actual pressure p_{A} at the utility port A is signaled via the corresponding signal channel 7 in the pressure regulating spool DRS to the right surface 11 of the pressure regulating spool DRS in the inner interstice in the form of the actual-pressure signal chamber Y and is compared to the pilot pressure p_{X} in the pilot chamber X using the equal-sized end face 1 on the left side of the pressure regulating spool DRS. The geometry of the pressure regulating spool DRS is formed in such a way that the chamberY and thus the surface 11 is always connected to the utility port A via the signaling channel 7. Depending on the pressure present at the measurement port 20 or in the signal chamber M, the pressure compensator is arranged in one of its two end positions or possibly in between. This only affects the spring force acting on the pressure regulating spool DRS and thus only slightly changes the regulating pressure at the utility port A.

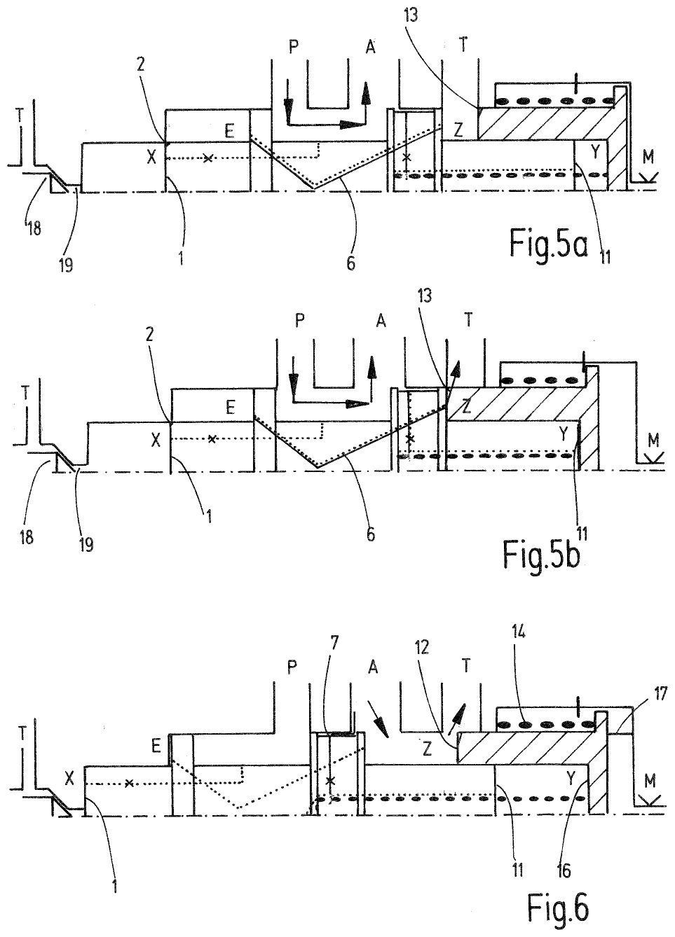

The following FIGS. 5a, 5b show the pressure regulating operation at saturation. If the set pressure, specified by energizing the pilot solenoid, at the pilot cone 18 cannot be reached because a very large volume flow flows out of the utility port A, there is no balance of forces between the surfaces 1 and 11 on the pressure regulating spool DRS without countermeasures, even if the flow path from the pressure supply port P to the utility port A is fully opened. As a result, the pressure regulating spool moves so far to the right that it closes the addressed fluid-conveying path P to A again, whereby the utility port pressure p_{A} further decreases and the spool leaves the regulation range. This is prevented by means of the triangular notch 2 on the pressure regulating spool DRS. The triangular notch 2 opens a connection from the pilot chamber X into the relief chamber E and from there via the compensation channel 6 and the interstice Z into the return port T. It has to be ensured by structure that the connection from the relief or compensation chamber E to the return port T is kept, even if the pressure compensator is arranged at its left stop, as shown in FIG. 5b. In this case, the relief notch 13 remains as a residual opening from the interstice Z to the tank port or return port T. The fluid (oil) flowing out via the notch 2 lowers the pilot pressure p_{X} to such an extent that a balance, determined by the utility port pressure p_{A}, between the utility port pressure p_{A} and the pilot pressure p_{X} is established. The pressure regulating spool DRS then remains within the sphere of action of the notch 2. The stability of this state depends essentially on the selected notch geometry. It also has to be ensured that the flow resistances across the compensation channel 6 and the relief notch 13 are significantly smaller than the resistance across the notch 2. The latter's resistance may not exceed that of the fully open pilot cone seat 19.

The pressure compensator operation is shown in FIG. 6 below. If the pilot pressure p_{X} in the pilot control chamber X is smaller than the working pressure at the utility port A or in the chamber Y, the resulting force acting on the surfaces 1 and 11 of the pressure regulating spool DRS moves the pressure regulating spool DRS into the left end position as shown in the illustration in FIG. 6. In this way, the cross section from the utility port A to the interstice Z is fully opened. The working pressure p_{A} then acts directly on the left annular surface 12 and via the signaling channel 7 indirectly on the left circular surface 16 of the pressure compensator spool DWS as the signaling pressure. The pressure compensator spool DWS then compares the working pressure p_{A} to the measuring pressure p_{M}, which acts on the right annular surface 17 of the pressure compensator. The surface 17 corresponds to the sum of the surfaces 12 and 16. The pressure compensator spool DWS assumes a position in which the volume flow from the utility port A to the tank port or return port T is throttled at the throttling point between the interstice Z and the return port T in such a way that the measuring pressure p_{M} minus the regulating pressure difference Δp_{M} defined by the spring 14 results at the utility port A.

The solution according to the invention in its entirety an electro-hydraulic control for hydraulic drives is created that can operate in two directions in both motor and regenerative operation. A pilot-controlled proportional spool valve is used, which combines the function of a pressure reducer for the supply pressure control and a pressure compensator for the discharge flow regulation in one combination valve.

1. A valve device having
an inlet port (ZA) of an inlet side for supplying a hydraulic consumer with hydraulic fluid, wherein said hydraulic consumer can be connected to the inlet port (ZA),
an outlet port (AA) of an outlet side for discharging pressurized fluid from the connectable consumer, wherein, depending on the direction of actuation of this consumer, the inlet side becomes the outlet side and the outlet side becomes the inlet side,
a pressure supply port (P), and
a return port (T),
characterized in that
a pressure regulating device is acting on the respective inlet side and
a volume flow regulating device is acting on the respective outlet side.

2. The valve device according to claim 1, characterized in that the pressure regulating device and the volume flow regulating device each have a proportional valve (PV) and a pressure regulating valve (DRV) in addition to a pressure compensator (DW) regarding their functionality, which are interconnected and controlled such that, when the inlet port (ZA) is supplied from the pressure supply port (P) in one direction of flow, one pressure regulating valve (DRV) operates as a pressure regulator and, on the side of the outlet port (AA) when a predeterminable set pressure is exceeded at the other pressure regulating valve (DRV), the direction of flow reverses and the pressure fluid is discharged via the other proportional valve (PV) and the assigned pressure compensator (DW), which both work regarding their functionality as flow regulating valves, in the direction of the return port (T).

3. The valve device according to claim 1, characterized in that the respective pressure regulating valve (DRV) is a proportional spool valve, preferably a 3/2-way proportional spool valve, which , controlled by means of at least one proportional magnet (18), permits to set a setpoint pressure at the pressure regulating valve (DRV).

4. The valve device according to claim 1, characterized in that the respective pressure regulating valve (DRV) and the respective assigned pressure compensator (DW) are combined in terms of their functions to a combination valve.

5. The valve device according to claim 1, characterized in that the combination valve has two spools, which can be moved independently in a valve housing, in the form of a pressure regulating spool (DRS) and in the form of a pressure compensator spool (DWS), which control the possible fluid-conveying connections between the pressure supply port (P), the return port (T) and a working port (A), which in connection with a proportional valve (PV) forms the inlet port or the outlet port (ZA; AA), respectively, in the one and in the other opposite direction of flow.

6. The valve device according to claim 1, characterized in that the combination valve has inside the valve housing the chambers listed below:
a pilot chamber (X), in which a control pressure (pX), originating from the pressure supply port (P), acts on the pressure regulating spool (DRS) according to the action of the energized proportional solenoid,
a compensation chamber (E),
an interstice (Z) in the possible fluid-conveying connection between the utility port (A) and the return port (T), in which a control pressure (pZ) resulting from this connection acts,
an actual-pressure signal chamber (Y), in which a control pressure (pA) acts, which originates from the respective pressure existing at the utility port (A), and
a signal chamber (M), in which a control pressure (pM) acts on the pressure compensator spool (DWS) against the action of an energy storage device (14).

7. The valve device according to claim 1, characterized in that a pilot channel (5) for an orifice (3) or a flow regulating valve for a pilot control is incorporated in the pressure regulating spool (DRS), which orifice (3) or flow regulating valve connects the pressure supply port (P) to a signaling surface (1) in a fluid-conveying manner, which at least partially delimits the pilot chamber (X).

8. The valve device according to claim 1, characterized in that a compensation channel (6) is introduced in the pressure regulating spool (DRS), which connects the utility port (A) to the compensation chamber (E) in a fluid-conveying manner.

9. The valve device according to claim 1, characterized in that a signaling channel (7) is introduced into the pressure regulating spool (DRS), wherein the signaling channel (7) has an optionally therein arrangeable dampening orifice (8) and transmits the actual pressure (pA) at the utility port (A) into the actual-pressure signal chamber (Y), which is delimited by the pressure compensator spool (DWS) and a control end (11) of the pressure regulating spool (DRS), which is guided in the actual-pressure signal chamber (Y).

10. The valve device according to claim 1, characterized in that the pressure compensator spool (DWS) is supported on a further energy accumulator (10), which acts on the pressure regulating spool (DRS) extending through the actual-pressure signal chamber (Y).
